(19) United States
(12) Patent Application Publication
(10) Pub. No.: US 2005/0144602 A1
(43) Pub. Date: Jun. 30, 2005

(54) Methods and apparatus to compile programs to use speculative parallel threads

(76) Inventors: Tin-Fook Ngai, Santa Clara, CA (US); Zhao Hui Du, Shanghai (CN)

Correspondence Address: GROSSMAN & FLIGHT LLC, Suite 4220, 20 North Wacker Drive, Chicago, IL, 60606-6357, US

(21) Appl. No.: 10/734,959

(22) Filed: Dec. 12, 2003

(51) Int. Cl. G06F 9/45

(52) U.S. Cl. 717/151

(57) ABSTRACT

Methods and apparatus are disclosed to compile programs to use speculative parallel threads. An example method disclosed herein identifies a set of speculative parallel thread candidates; determines misspeculation cost values for at least some of the speculative parallel thread candidates; selects a set of speculative parallel threads from the set of speculative parallel thread candidates based on the cost values; and generates program code based on the set of speculative parallel threads.

### FIELD OF THE DISCLOSURE

This disclosure relates generally to program compilation, and, more particularly, to methods and apparatus to compile programs to use speculative parallel threads.

### BACKGROUND

Traditionally, computer programs have been executed in a largely sequential manner on a single processor, such as a microprocessor. In recent years, technological advances have brought about architectures that contain multiple, interconnected processors. These architectures support execution of more than one portion of a single program in parallel, thereby improving the execution time of the overall program. This type of architecture is often called a “parallel processing architecture,” “parallel processor” or “multi-processor,” and the resulting execution of the program is termed “parallel processing.”

A typical use of parallel processing is to speed the execution of a sequential program by dividing the program into a main thread and one or more parallel threads and assigning the parallel threads to separate processors. The main thread is the primary execution path, and may start, or “spawn,” additional parallel threads as appropriate. Each thread may execute on a separate processor, and information is shared between processors as needed based on the program execution flow. When two or more threads executing in parallel need to access the same data variable, a “data dependency” exists between the affected threads. In this case, the possibility exists that one of the threads may access the variable at an incorrect point in the overall program flow (i.e., before the data in the variable has been updated by another thread executing a process that should occur earlier in time than the instruction accessing the variable). In such a circumstance, the thread accessing the variable at the incorrect point may operate on an erroneous data value. This condition is known as a “data dependency violation,” and requires that the offending thread (or at least a portion thereof) be re-executed after the violation is identified, thus negating much, if not all, of the benefit gained through parallel processing of the thread. Indeed, a data dependency violation may result in slower overall execution of the relevant section of the program than would have occurred had the program been executed sequentially by a single processor.

Until recently, software developers had to manually write program code to take advantage of the full capability of parallel processing architectures. For example, the programmer would add locks or synchronization primitives to prevent data dependency violations. However, such an approach relies on the expertise of the individual programmer, and may result in sub-optimal code, or code that has conservative parallelism. Moreover, to take advantage of the parallel processing capabilities of parallel architectures, existing, sequential program code had to be ported by hand to the parallel processing architecture; a task that can be both costly and time consuming.

However, today's program compilers have become more sophisticated and, thus, are able to recognize the potential for executing a given program in multiple threads as supported by the target multiple processor architectures. A class of these compilers attempts to identify, or “speculate” on, which portions of the program can be executed in parallel threads. Thus, these threads are termed “speculative parallel threads.”

### BRIEF DESCRIPTION OF THE DRAWINGS

FIG. 1 is a schematic illustration of an example apparatus to compile programs using speculative parallel threads.

FIG. 2 is a more detailed schematic illustration of the example candidate identifier of FIG. 1.

FIG. 3 is a diagram illustrating an example manner in which program regions are identified and executed in separate, parallel threads.

FIG. 4 is a diagram illustrating an example manner in which a program loop may be identified in a program and sequential iterations of the program loop may be executed in separate, parallel threads.

FIGS. 5A-5C are diagrams illustrating an example data dependency violation and two examples in which no data dependency violations occur.

FIG. 6 is a diagram illustrating an example program execution flow with two possible execution paths.

FIG. 7 is a more detailed schematic illustration of the example speculative parallel thread (SPT) selector of FIG. 1.

FIGS. 8A-8B are flowcharts representative of a first example of machine readable instructions which may be executed by a machine to implement the candidate identifier of the apparatus of FIG. 1.

FIGS. 9A-9B are flowcharts representative of a second example of machine readable instructions which may be executed by a machine to implement the candidate identifier of the apparatus of FIG. 1.

FIGS. 10A-10B are flowcharts representative of example machine readable instructions which may be executed by a machine to implement the SPT selector of the apparatus of FIG. 1.

FIG. 11 is a flowchart representative of example machine readable instructions which may be executed by a machine to implement the metric estimation operations performed by the metric estimator and transformer of the apparatus of FIG. 1.

FIG. 12 is a schematic illustration of an example computer that may execute the programs of FIGS. 8A-8B, 9A-9B, 10A-10B and 11 to implement the apparatus of FIG. 1.

FIG. 13 is a diagram illustrating an example identification of a set of speculative parallel thread candidates and subsequent generation of parallel processing code based on the selection of a set of speculative parallel threads.

### DETAILED DESCRIPTION

As mentioned previously, parallel processing can be used to improve the execution time of computer programs. This improvement is achieved by executing a main program thread and one or more parallel threads on two or more separate processors within a system. Because a parallel thread may be executed while the main thread that spawned the parallel thread is also executing, overall program execution may be expedited relative to sequential execution of that same program on a single processor.

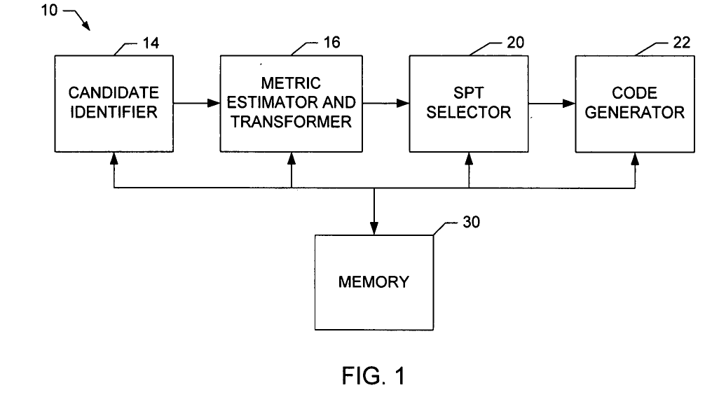

An example apparatus 10 to compile a program to use parallel threads in a substantially optimized fashion is shown in FIG. 1. As explained in detail below, the illustrated apparatus 10 strives to compile a program to spawn speculative parallel threads that will minimize the execution time of the compiled program by seeking to reduce the possibility of executing threads that result in data dependency violations.

The illustrated apparatus 10 first parses the program to determine its constituent code constructs. These constructs may be used by other elements of the apparatus 10, for example, to identify program regions and program loops. The apparatus 10 then attempts to identify regions and/or loops that are candidates for execution in a parallel thread off of the main thread. As this involves speculation, the resulting parallel thread candidates are referred to as “speculative parallel thread candidates” or “SPT candidates.” A speculative parallel thread candidate comprises a first set of code segments (e.g., regions and/or loops) that could execute in the main thread, and a second set of code segments that could execute in a speculative parallel thread off of the main thread. Moreover, different speculative parallel thread candidates may comprise one or more similar, or even identical, code segments. To generate the program code for parallel processing, the assignment of the code segments to the main thread and to the one or more speculative parallel threads occurs through a selection of a set of speculative parallel threads from the set of speculative parallel thread candidates.

Once the apparatus 10 has identified a set of speculative parallel thread candidates, the apparatus 10 will then select speculative parallel threads from among the set of candidates. Once the speculative parallel threads are selected, the apparatus generates compiled program code. As part of the speculative parallel thread candidate identification and the code generation processes, the apparatus 10 may attempt to further optimize the generated code by performing a code transformation on one or more of the threads. Example code transformations including replacing one set of instructions with a different set of instructions optimized for the target processor, or reordering the code in the thread to execute more efficiently.

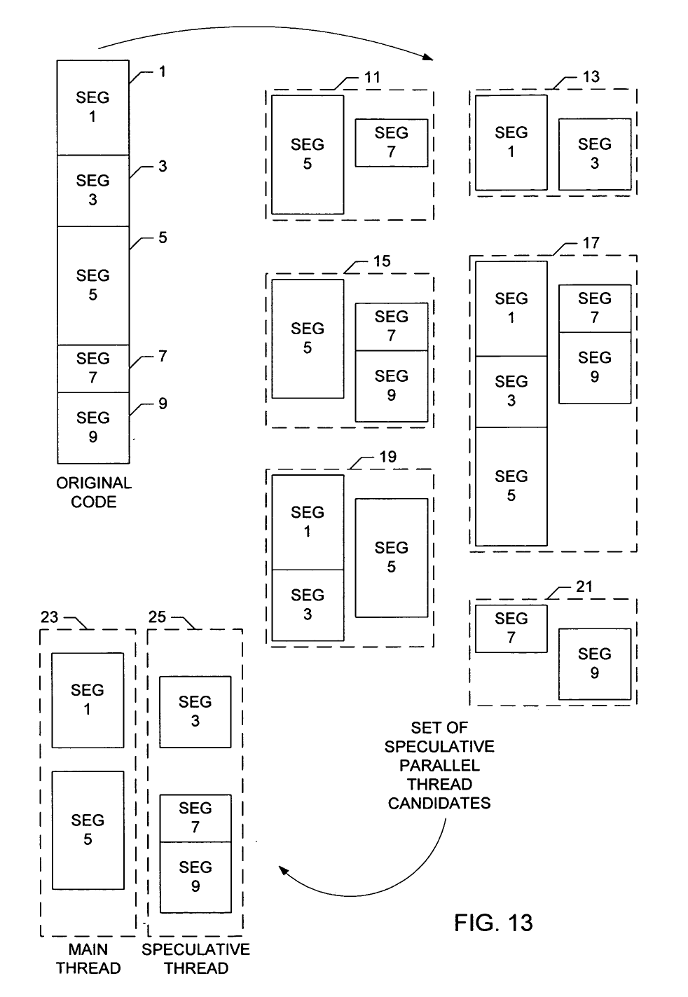

By way of example, FIG. 13 depicts the identification of a set of speculative parallel thread candidates from an original program code, and then the subsequent generation of program code for execution on a parallel processor based on the selection of a set of speculative parallel threads. In the example of FIG. 13, the original program code comprises five code segments, 1, 3, 5, 7 and 9. Using the methods and/or apparatus described below, the compiler identifies six speculative parallel thread candidates, 11, 13, 15, 17, 19 and 21. Candidate 11 comprises code segment 5 in a main thread and code segment 7 in a speculative parallel thread. Similarly, candidate 17 comprises code segments 1, 3 and 5 in a main thread, and code segments 7 and 9 in a speculative parallel thread. In the interest of brevity, the code segments that comprise the remaining candidates 13, 15, 19 and 21 are shown in FIG. 13 and will not be reiterated herein. In FIG. 13, the segment in the left half of a candidate is the spawning segment and the segment in the right half is the segment that is potentially spawned. Once the set of speculative parallel thread candidates is available, the compiler uses the methods and/or apparatus described below to select a set of speculative parallel threads from which to generate the parallel processing code. In the example of FIG. 13, the compiler selects the speculative parallel threads of candidates 13 and 15, and, therefore, assigns code segment 1 to the main thread and code segment 3 to a speculative parallel thread spawned by segment 1. Similarly, the compiler assigns code segment 5 to the main thread and code segments 7 and 9 to a speculative parallel thread spawned by segment 5.

As described above, threads that execute in parallel may have data dependencies that could result in data dependency violations. As a result, the apparatus 10 strives to select speculative parallel threads having reasonably low chances of incurring data dependency violations. However, given that the program execution flow of complex software programs is difficult to determine a priori with certainty, it is still possible that a violation will occur during program execution. When a data dependency violation occurs, a “misspeculation” is said to have occurred, and the offending thread may need to be re-executed in its entirety, or in part. Therefore, the illustrated apparatus 10 attempts to compile programs for parallel processors by determining good speculative parallel threads that result in a low probability of misspeculation and achieve a good degree of parallelism.

For the purpose of identifying a set of speculative parallel thread candidates, the apparatus 10 of FIG. 1 is provided with a candidate identifier 14. In the illustrated example, the candidate identifier 14 reads the original program code from a memory 30. The candidate identifier 14 then examines the original program code and evaluates portions thereof to determine if they should be included in the set of speculative parallel thread candidates.

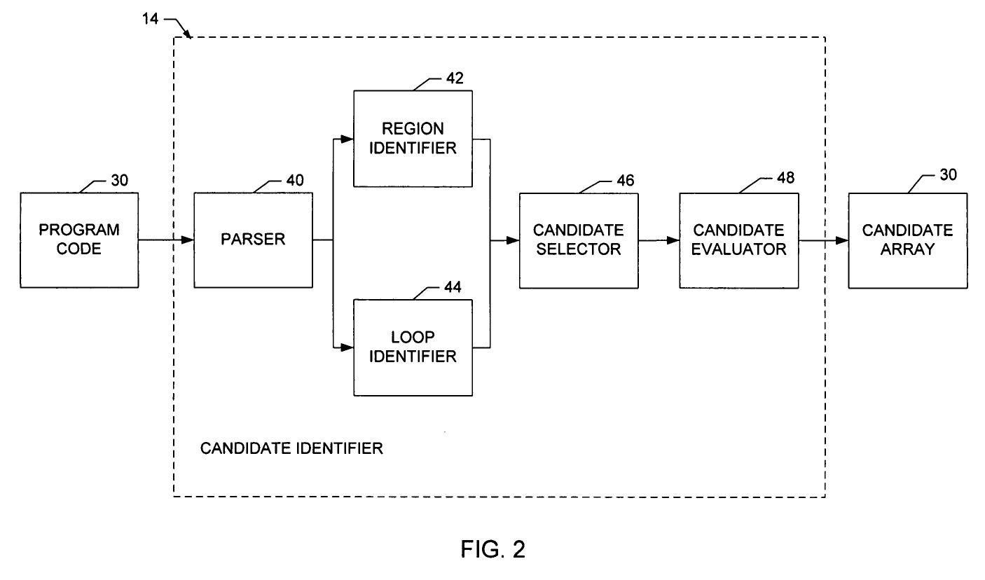

An example candidate identifier 14 is shown in greater detail in FIG. 2. As mentioned previously, the candidate identifier 14 reads the original program code from memory 30. To focus on specific portions of the original program code, the candidate identifier 14 may include any or all of the following: a parser 40 to parse the code into its constituent code constructs, a region identifier 42 to identify program regions within the program code, a loop identifier 44 to identify program loops within the program code, and a candidate selector 46 to select code segments that could be executed in a main thread and/or one or more speculative parallel threads.

Persons of ordinary skill in the art will readily appreciate that many techniques can be used to parse the code, identify program regions, identify program loops and select code segments that could be executed in the main thread and/or the parallel thread(s). Code parsers 40 are well-known in the art and will not be discussed further herein. The region identifier 42 may segment the code into regions by searching for specific constructs used in the programming language, or by using a simple counter to add instructions to a region until a predetermined number of instructions is reached. Typically, the region identifier 42 will attempt to identify “good” regions that have either a single entry point and a single exit point, or a single entry point and multiple exit points.

Loop analysis is a typical operation performed by conventional compilers. Thus, an example loop identifier 44 could identify loops by searching for specific constructs in the programming language that mark the beginning and end of the loop. Finally, an example candidate selector 46 could use the code constructs of the programming language to select those code segments that could be executed in the main thread and those that could be executed in one or more speculative parallel threads. For example, the candidate selector 46 could select the first and each subsequent odd iteration of a program loop as code segments for possible execution in the main thread, thereby leaving even iterations of the loop as code segments for possible execution in one or more speculative parallel threads. As another example, the candidate selector 46 could select a first set of one or more code regions as a first code segment for possible execution in the main thread, and a second set of one or more code regions of similar size as the first code segment for possible execution in one or more speculative threads. As one with ordinary skill in the art will recognize, the number of potential selections can be large, especially as the regions identified by the region identifier 42 may overlap, and the loops identified by the loop identifier 44 may be nested.

To evaluate whether or not code segments (comprising regions and/or loops) selected by the candidate selector 46 should be identified as a speculative parallel thread candidate, the candidate identifier 14 also includes a candidate evaluator 48. The candidate evaluator 48 evaluates the code segments selected by the candidate selector 46 using various criteria, for example, the size of the selected code segments, and the likelihood that the code segments will be reached during program execution. As one having ordinary skill in the art will appreciate, larger code segments, in which the code segments in the main thread and in the one or more speculative parallel threads substantially overlap, result in more parallelism and, thus, a greater potential for improving overall program execution speed. The likelihood of code segment execution provides an indication of how probable the desired parallelism will be achieved by using the selected code segments. The likelihood of code segment execution may be determined through a program flow analysis. Program flow analysis may be based on heuristic rules that estimate this likelihood by using the code constructs in the code segment to make assumptions regarding the program control flow. For example, the candidate evaluator 48 could assume an evenly distributed probability for each control flow branch within the selected code segments. Program flow analysis may also be based on profiling information, if available, to yield an even more accurate estimate of the likelihood of code segment execution. One having ordinary skill in the art will realize that other techniques may be used to conduct the program flow analysis on the selected code segments.

Once the candidate evaluator 48 has identified the code segments selected by the candidate selector 46 as being a speculative parallel thread candidate, information related to the candidate is stored in memory 30, for example, as an entry in a candidate array. For example, the candidate array 30 could contain a description of the speculative parallel thread candidate sufficient to reconstruct the candidate from the original program code. In another example, the candidate array 30 could contain a copy of the original program code that comprises the speculative parallel thread candidate. In a third, preferred example, the candidate array 30 could contain pointers to the appropriate code segments in the original program code that comprise the speculative parallel thread candidate.

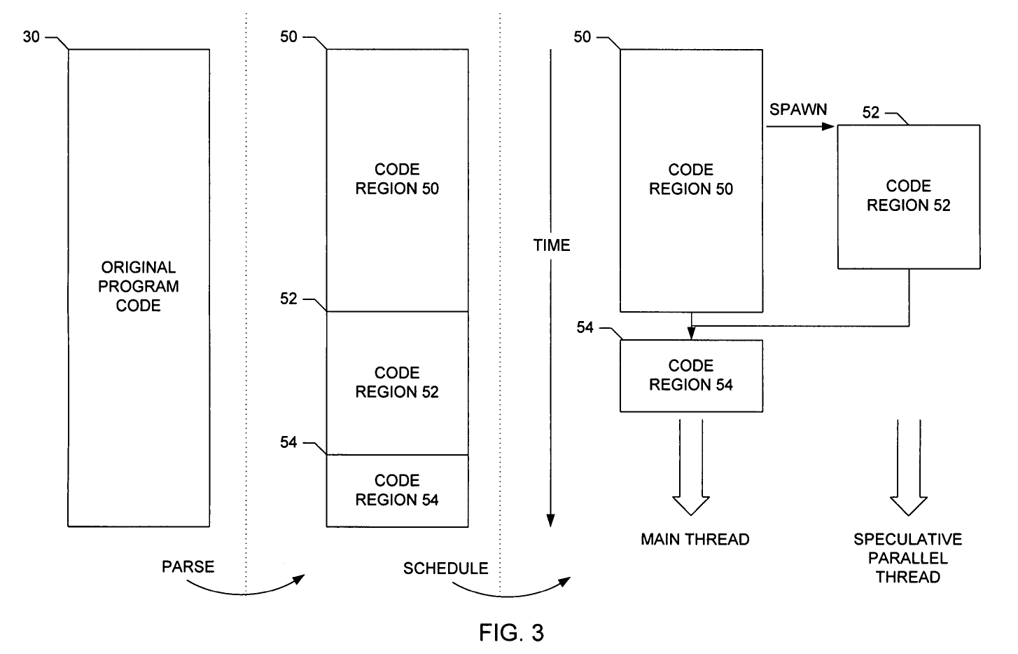

To better understand the operation of the candidate identifier 14, consider the diagram in FIG. 3 that illustrates an example manner in which program regions are identified and executed in separate, parallel threads. In this example, the original program code 30 is segmented by the region identifier 42 into three code regions, namely, code region 50, code region 52 and code region 54. Based on the content of code region 50 and code region 52, the candidate selector 46 determines that code region 50 could be executed in the main thread, thereby leaving code region 52 for consideration as a code region to execute in a speculative parallel thread. The candidate selector 46 examines the content of code regions 50 and 52 (i.e., a speculative parallel thread candidate) to determine if these code regions can be executed in parallel threads. In the example of FIG. 3, the candidate selector 46 determines that code region 52 can be spawned as a parallel thread by code region 50 and executed in a parallel thread. Then, the candidate evaluator 48 uses the criteria described previously to evaluate the output of the candidate selector 46 and, in this example, determines that the code regions 50 and 52 qualify as a speculative parallel thread candidate as defined by the candidate selector 46. Thus, code regions 50 and 52 are stored in the candidate array 30 as a speculative parallel thread candidate.

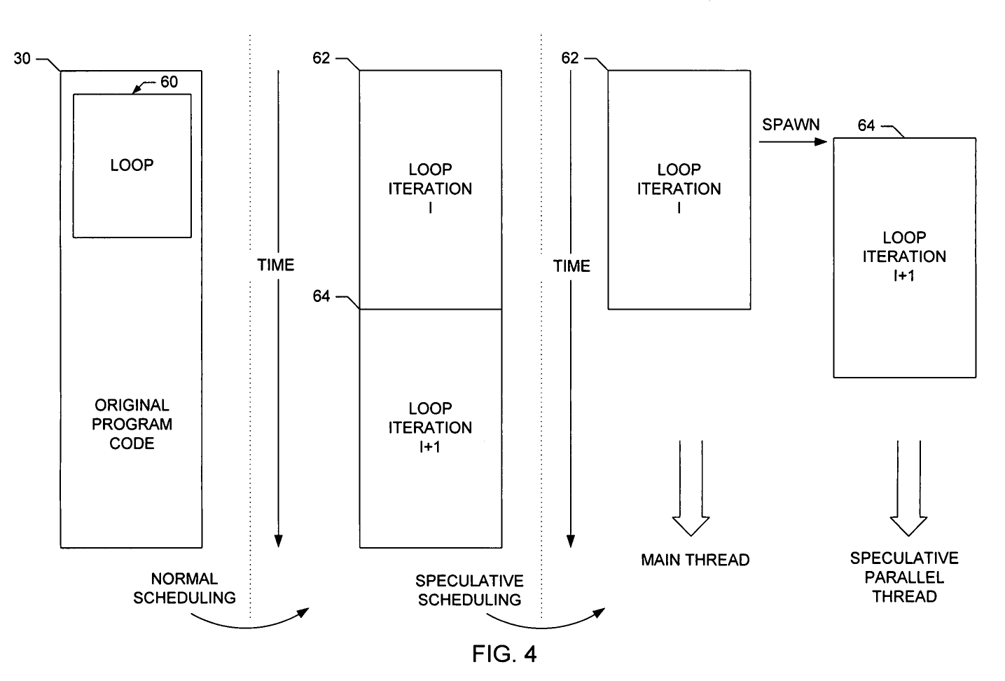

As another example illustrating the operation of the example candidate identifier 14, consider the diagram in FIG. 4 which depicts an example manner in which a program loop is identified in a program and sequential iterations of the program loop are executed in separate, parallel threads. In this example, the original program 30 is processed by the loop identifier 44, which identifies a program loop 60 within the program code 30. The candidate selector 46 examines two successive iterations of the program loop 60, loop iteration 62 and loop iteration 64. In the example of FIG. 4, the candidate selector 46 determines that loop iteration 62 could be scheduled to execute in the main thread, thereby leaving loop iteration 64 for consideration as a loop iteration to execute in a speculative parallel thread. In this example, the candidate selector 46 determines that loop iteration 64 can be scheduled to be executed in a parallel thread and spawned by loop iteration 62. Then, the candidate evaluator 48 uses the criteria described previously to evaluate the output of the candidate selector 46 and, in this example, determines that the loop iterations 62 and 64 qualify as a speculative parallel thread candidate as defined by the candidate selector 46. Thus, loop iteration 62 and 64 are stored in the candidate array 30 as a speculative parallel thread candidate.

To quantify the benefit that a particular speculative parallel thread will have on the overall program execution flow, the example apparatus 10 of FIG. 1 includes a metric estimator and transformer 16. In the illustrated example, the metric estimator and transformer 16 reads a speculative parallel thread candidate from the candidate array 30, calculates a cost metric associated with this candidate and stores the cost metric in the memory 30. One example cost metric that may be used by the metric estimator and transformer 16 is misspeculation cost. Misspeculation cost is a quantity that is a function of the likelihood of a data dependency violation within the speculative parallel thread candidate, and the amount of computation required to recover from the data dependency violation. By associating a cost metric, and particularly a misspeculation cost, with the speculative parallel thread candidate, the compiler is able to select the speculative parallel threads from among the potentially numerous speculative parallel thread candidates that result in the lowest misspeculation cost, that is, the lowest probability of misspeculation and, thus, the best degree of parallelism. Moreover, as described in greater detail below, the metric estimator and transformer 16 is able to select the best code transformation from among a set of code transformations for a given candidate to yield a minimum cost for that speculative parallel thread candidate.

In the illustrated metric estimator and transformer 16 the misspeculation cost is determined as follows. First, the metric estimator and transformer 16 searches for data dependencies between the main thread code segments and the corresponding speculative parallel tread code segments in the speculative parallel thread candidate. Second, for an identified data dependency, the metric estimator and transformer 16 estimates the likelihood, or probability, that a violation will occur for the data dependency, denoted as P_{V,I} for the I^{th} data dependency. One having ordinary skill in the art will appreciate that there are many ways to determine this probability. For example, the metric estimator and transformer 16 could employ a predetermined set of heuristics that estimate the likelihood of a dependency violation based on the programming language constructs within the speculative parallel thread candidate. In another example, the metric estimator and transformer 16 could use profiling information, if available, to estimate the probability that a violation will occur for the data dependency. In yet another example, the metric estimator and transformer 16 could assume a predetermined value for the probability of the dependency violation. The preferred approach depends on the resources available to the compiler, as well as the target for which the program code is being compiled.

As a third component of the misspeculation cost determination, the metric estimator and transformer 16 determines an amount of processor computation required to recover from the data dependency violation. As one possessing ordinary skill in the art will appreciate, this amount of computation depends on the target architecture on which the program is executed. For example, some architectures may require that the master thread re-execute the entire contents of the speculative parallel thread if a dependency violation occurs. In other architectures, computations affected by the dependency violation only need be re-executed. In the former case, the amount of computation required for recovery is simply the execution time of the speculative parallel thread, denoted as S_{SPT}. In the latter case, the amount of computation required to recover from a dependency violation for the I^{th} data dependency is denoted S_{D,I}.

Thus, for the example metric estimator and transformer 16 described above, an example function for determining the misspeculation cost, denoted C_{SPT}, is as follows. If the entire thread contents must be re-executed upon violation, then the misspeculation cost is determined by multiplying the size of the speculative parallel thread candidate by the total probability of any data dependency violation for this candidate, or:
C_{SPT}=S_{SPT}ΣP_{V,I}.
In the preceding equation, the size of the speculative parallel thread candidate is defined to be the execution time for the set of code segments included in the speculative parallel thread for this candidate, i.e., S_{SPT}. If only the affected computations must be re-executed upon occurrence of a data dependency violation, then the misspeculation cost is determined by totaling the probability of each possible data dependency violation for this candidate weighted by the recovery computation size for the dependency violation, or:
C_{SPT}=Σ(S_{D,I}P_{V,I}).
In the preceding equations, the sum (Σ) is over all the data dependencies identified for the particular speculative parallel thread candidate. One having ordinary skill in the art will recognize that the summations shown in the preceding equations may not be performed in the strict sense. For example, depending on the locations of the data dependencies in the speculative parallel thread candidate, the summation operation may also need to account for overlapping recovery computation sizes.

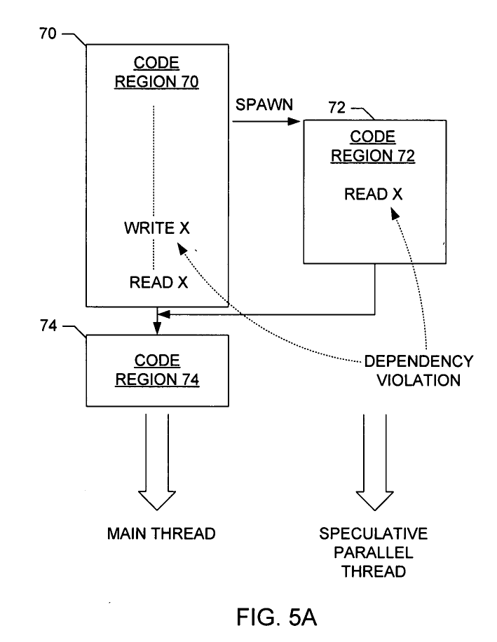

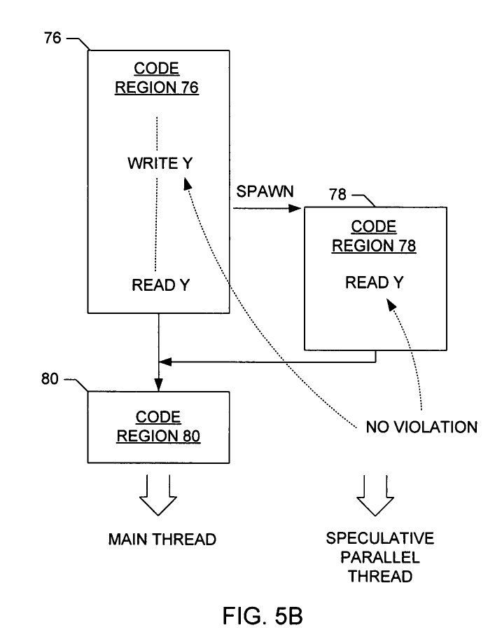

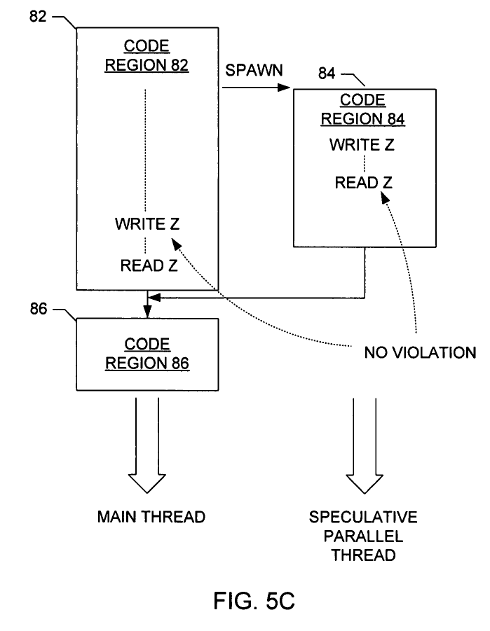

To better illustrate the identification of data dependencies, FIGS. 5A-5C contain diagrams illustrating an example data dependency violation and two examples in which no data dependency violations occur. In the example shown in FIG. 5A, the region identifier 42 of FIG. 2 processes the original program code 30 and identifies three code regions: code region 70, code region 72 and code region 74. The candidate selector 46 determines that code region 70 could be executed in the main thread and that code region 72 could be executed in a parallel thread. However, both code region 70 and code region 72 operate on a common variable, denoted as ‘X’ in FIG. 5A. In this example, the original program execution flow would have been such that code region 70 would write a new value to variable X before code region 72 reads the value in variable X. However, if code region 72 is executed in a parallel thread, the value in variable X is read before code region 70 is able to write the new value. In this case, code region 72 will process an erroneous value from variable X, and thus a data dependency violation will occur.

In the example shown in FIG. 5B, the region identifier 42 processes the original program code 30 and identifies three code regions, namely, code region 76, code region 78 and code region 80. The candidate selector 46 determines that code region 76 could be executed in the main thread and that code region 78 could be executed in a parallel thread. As in the previous example, both code region 76 and code region 78 operate on a common variable, denoted as ‘Y’ in FIG. 5B. In this example, the original program execution flow would have been such that code region 76 would write a new value to variable Y before code region 78 reads the value in variable Y. In this case, however, if code region 78 is executed in a parallel thread, the value in variable Y is still read after code region 76 has written the new value. Thus, no data dependency violation will occur.

In the example shown in FIG. 5C, the region identifier 42 processes the original program code 30 and identifies three code regions, namely, code region 82, code region 84 and code region 86. The candidate selector 46 determines that code region 82 could be executed in the main thread and that code region 84 could be executed in a parallel thread. As in the previous examples, both code region 82 and code region 84 operate on a common variable, denoted as ‘Z’ in FIG. 5C. In this example, the original program execution flow would have been such that code region 82 would write a value to variable Z and read that value from variable Z before code region 84 writes a new value to variable Z and reads that new value from variable Z. In this case, if code region 84 is executed in a parallel thread, code region 82 and 84 perform the mutually exclusive operations of writing a new value to variable Z before reading that value from variable Z. Thus, no data dependency violation will occur.

One having ordinary skill in the art will appreciate that data dependencies that are less definite than those illustrated in FIGS. 5A-C may result from the conditional execution of program regions and/or loops (e.g., due to an if-then-else programming construct). In these cases, the data dependencies between the main and speculative parallel threads will depend upon which of potentially several different code regions/loops are executed as a result of the value of a conditional expression at a given point in the program execution flow. Hence, the metric estimator and transformer 16 determines a set of potential data dependencies for the different possible conditional execution flows, and then determines a probability for a particular data dependency as described previously. Also, one having ordinary skill in the art will realize that other factors, in addition to those mentioned herein, may result in data dependencies, some of which may not be completely deterministic at program compile time.

In addition to the cost metric determined by the example metric estimator and transformer 16 of FIG. 1, the example candidate evaluator 48 of FIG. 2 may determine additional information useful for characterizing the potential benefit of a particular speculative parallel thread candidate. For example, the candidate evaluator 48 may determine the size of the speculative parallel thread candidate and store this information in the memory 30. This size could be used to estimate the amount of parallelism, and, thus, the improvement in execution time, that could result from executing the candidate in a parallel thread. As another example, the candidate evaluator 48 may determine a likelihood, denoted as P_{SPT}, that represents a probability that, during program execution, the code segments in the main thread of the speculative parallel thread candidate will reach the code segments in the speculative parallel thread(s) of the speculative parallel thread candidate. The candidate evaluator 48 then stores this information in memory 30. This likelihood of execution information could be used to select between multiple speculative parallel thread candidates that have overlapping code segments. The likelihood of execution information can also be used to select between multiple speculative parallel thread candidates that have similar code segments in the main execution thread, but different code segments in their speculative parallel thread(s), especially in cases where the target architecture has limited resources and can support only a few, simultaneous parallel threads.

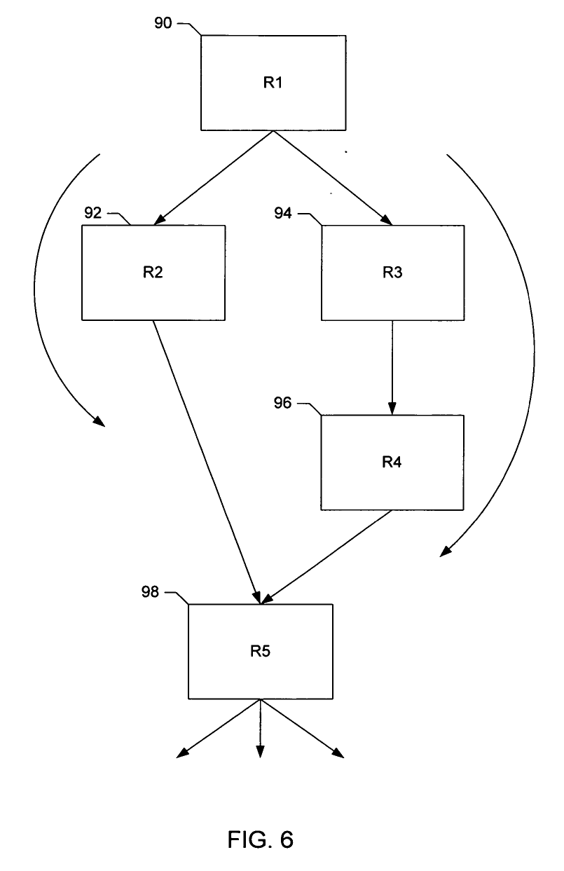

To illustrate the benefit of determining the likelihood of execution, FIG. 6 contains a diagram that depicts an example program execution flow that has two possible execution paths. In this example, one possible path contains code regions 90, 92 and 98, whereas the second possible path contains code regions 90, 94, 96 and 98. Furthermore, assume that the candidate selector 46 and the candidate evaluator 48 have identified two speculative parallel thread candidates. The first candidate contains region 90 in the main execution thread and region 92 in the speculative parallel thread, and the second candidate contains region 90 in the main execution thread and regions 94 and 96 in the speculative parallel thread. Next, assume that the candidate evaluator 48 determines that the size of the second candidate is greater than the size of the first candidate. If size alone is used as the criteria for selecting the speculative parallel thread, the second candidate would be selected as it would provide a higher degree of parallelism, that is, the additional code needed to execute the code segments in the parallel thread would result in a lower percentage of overhead for the second candidate than for the first candidate. However, if the first candidate is more likely to exist in the overall program execution flow, then executing code regions 94 and 96 in the parallel thread will provide little or no benefit to overall execution time as the results of their execution are likely to not be needed, and code region 92 will still need to be executed in a sequential fashion following code region 90. Thus, the likelihood of execution, in addition to the cost metric and thread size, can be a useful piece of information in selecting speculative parallel threads.

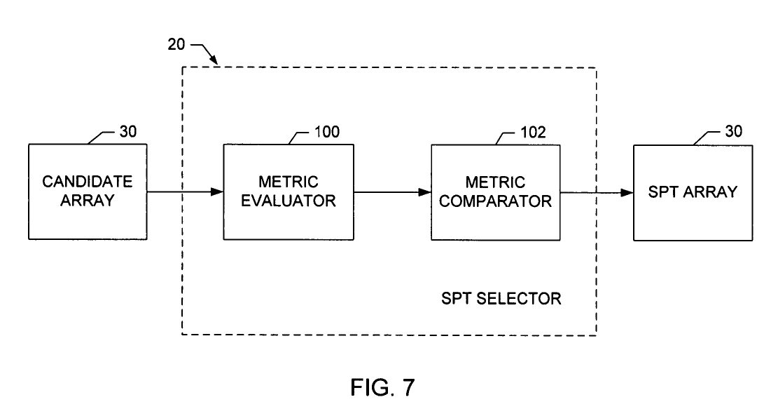

To select one or more speculative parallel threads from the set of speculative parallel thread candidates identified by the candidate identifier 14, the example apparatus 10 of FIG. 1 includes a speculative parallel thread (SPT) selector 20. The SPT selector 20 selects the speculative parallel threads from the speculative parallel thread candidates based on the information stored in memory 30 by the metric estimator and transformer 16 and the candidate evaluator 48. An example SPT selector 20 is shown in FIG. 7. In the illustrated example, the SPT selector 20 reads the information for the speculative parallel thread candidates from the candidate array 30 in memory. To develop a benefit-cost ratio for each of the speculative parallel thread candidates, the SPT selector 20 is provided with a metric evaluator 100. The metric evaluator 100 examines the information stored by the metric estimator and transformer 16 and the candidate evaluator 48 for the speculative parallel thread candidate and evaluates the benefit that this speculative parallel thread candidate would have on overall program execution. For example, if the metric estimator and transformer 16 and candidate evaluator 48 store the misspeculation cost (C_{SPT}), the size (S_{SPT}) and the likelihood of execution (P_{SPT}) for the speculative parallel thread candidate, the metric evaluator 100 could calculate a benefit-cost ratio associated with this candidate as:
Benefit-Cost Ratio=S_{SPT}P_{SPT}/C_{SPT}
In other words, the benefit-cost ratio could be calculated by weighting the size of the speculative parallel thread candidate by the likelihood that this candidate would occur in the program execution flow, and then inversely weighting by the cost so that a lower cost results in a larger benefit. One having ordinary skill in the art will readily appreciate that this is just one example of an evaluation that the metric evaluator 100 could perform, and that the type of evaluation employed will depend on the available information.

To compare the benefit-cost ratios associated with more than one speculative parallel thread candidate, the example SPT selector 20 includes a metric comparator 102. The metric comparator 102 ranks the speculative parallel tread candidates so that it is possible to select speculative parallel threads that will be most beneficial for the resulting overall program execution. This ranking may be necessary if, for example, more than one speculative parallel thread candidate contain code segments that overlap or are substantially equivalent. The ranking may also be necessary if, for example, the physical architecture has limited resources, and can support only a few, simultaneous parallel threads. Other examples of the need to rank the speculative parallel thread candidates include the case when compilation resources are limited so that the number of speculative parallel threads that can be compiled is restricted, or the case when compilation time is a concern, thereby restricting the number of speculative parallel threads that can be processed. In the event that such limitations exist, the metric comparator 102 may limit the number of selected parallel threads to be within the number supported by the physical architecture and/or compiler.

Once the speculative parallel threads are selected, information to describe the speculative parallel threads is stored in memory 30, for example, as an SPT array. In one example, the SPT array 30 could contain a description of the speculative parallel thread(s) sufficient to reconstruct the thread(s) from the original program code 30. In another example, the SPT array 30 could contain a copy of the original program code 30 that comprises the speculative parallel thread. In a third, preferred example, the SPT array 30 could contain pointers to the appropriate code segments in the original program code that comprise the speculative parallel thread.

To generate the resulting parallel processing code based on the speculative parallel threads, the example apparatus 10 illustrated in FIG. 1 includes a code generator 22. The code generator 22 reads the original program code and the SPT array from memory 30, modifies the original program code to support execution using the identified speculative parallel threads, and generates the resulting parallel processing code. The approach used to assign a parallel thread to a processor depends on the target machine. Some machines have implicit threading capability built into their hardware. Others require that the program use utilities provided by the operating system to assign parallel threads to a specific processor. Once generated, the parallel processing code is stored in memory 30 for execution on the target architecture.

To produce even more efficient code, the apparatus 10 may perform transformations on the code at various stages during code compilation. For example, the metric estimator and transformer 16 may perform transformations on the speculative parallel thread candidates to reduce the cost associated with the candidate. This process could be iterative so that a minimum cost for the speculative parallel thread candidate is determined. Similarly, the code generator 22 may transform the speculative parallel threads to increase the efficiency of the code. So that the cost benefit of using a particular speculative parallel thread is consistent, the metric estimator and transformer 16 may store information in memory that would allow the code generator 22 to use the same transformation on the speculative parallel thread that achieved the stored cost metric for the associated speculative parallel thread candidate. Persons having ordinary skill in the art will recognize that various code transformations can be used by the apparatus 10. Example code transformations include replacing one set of instructions with a different set of instructions optimized for the target processor, or reordering the code in the thread to execute more efficiently.

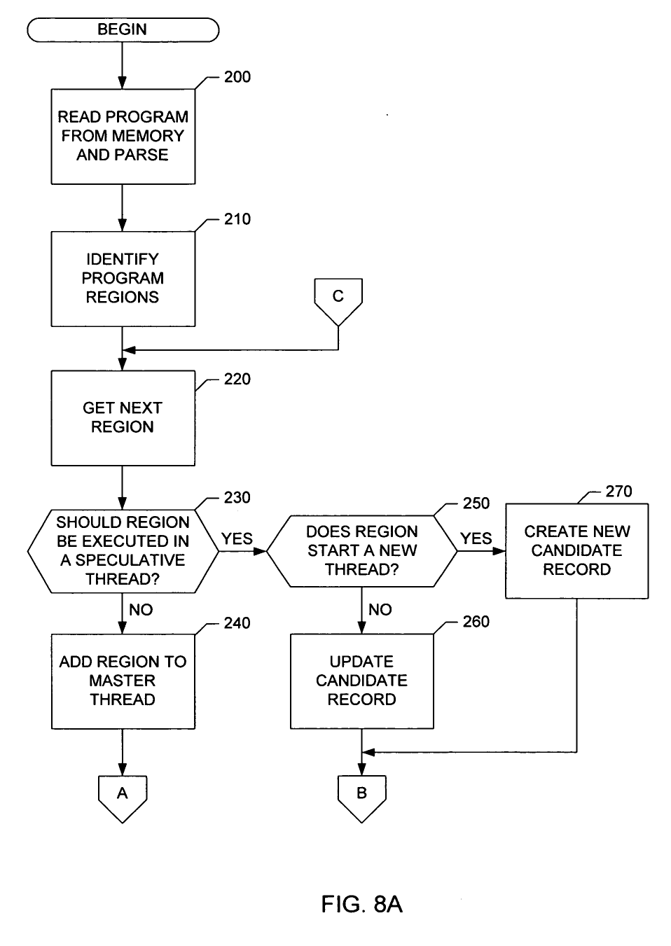

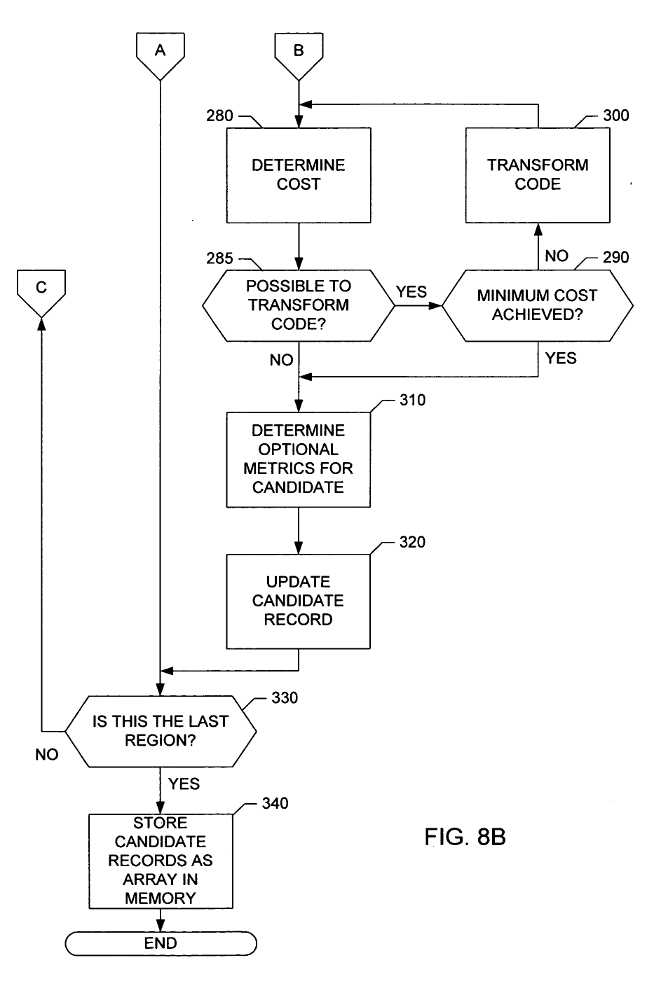

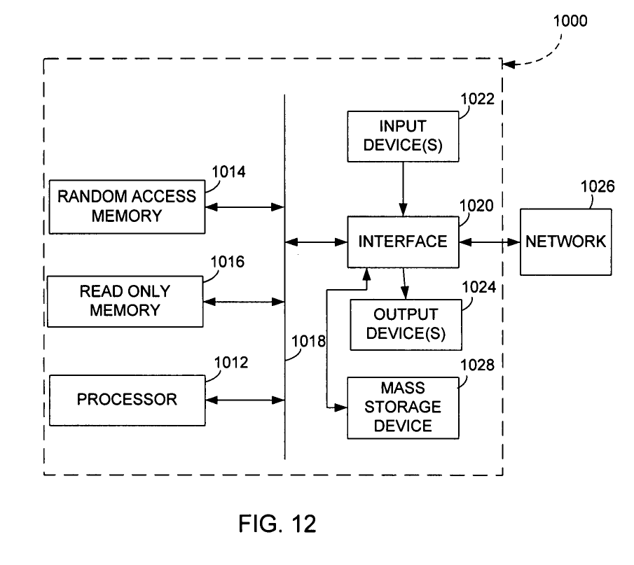

Flowcharts representative of example machine readable instructions for implementing the apparatus 10 of FIG. 1 are shown in FIGS. 8A-8B, 9A-9B, 10A-10B and 11. In this example, the machine readable instructions comprise a program for execution by a processor such as the processor 1012 shown in the example computer 1000 discussed below in connection with FIG. 12. The program may be embodied in software stored on a tangible medium such as a CD-ROM, a floppy disk, a hard drive, a digital versatile disk (DVD), or a memory associated with the processor 1012, but persons of ordinary skill in the art will readily appreciate that the entire program and/or parts thereof could alternatively be executed by a device other than the processor 1012 and/or embodied in firmware or dedicated hardware in a well known manner. For example, any or all of the candidate identifier 14, the parser 40, the region identifier 42, the loop identifier 44, the candidate selector 46, the candidate evaluator 48, the metric estimator and transformer 16, the SPT selector 20, the metric evaluator 100, the metric comparator 102 and/or the code generator 22 could be implemented by software, hardware, and/or firmware. Further, although the example program is described with reference to the flowcharts illustrated in FIGS. 8A-8B, 9A-9B, 10A-10B and 11, persons of ordinary skill in the art will readily appreciate that many other methods of implementing the example apparatus 10 may alternatively be used. For example, the order of execution of the blocks may be changed, and/or some of the blocks described may be changed, eliminated, or combined.

An example program to identify speculative parallel thread candidates is shown in FIGS. 8A-8B. The program begins at block 200 where the candidate identifier 14 reads the original program code from memory 30 and the parser 40 parses the code into its constituent constructs. After the program code is read from memory and parsed, the region identifier 42 identifies program regions (block 210) by, for example, segmenting the code into regions by searching for specific constructs used in the programming language, or by adding instructions to a region until a desirable flow structure is achieved. Typically, the region identifier will attempt to identify “good” regions that have either a single entry point and a single exit point, or a single entry point and multiple exit points. Once one or more program regions are identified, the candidate selector 46 of the candidate identifier 14 gets a region to process (block 220). Control then proceeds from block 220 to block 230.

The candidate identifier 14 then determines whether the region being examined should be executed in a speculative parallel thread (block 230). To do this, the example candidate selector 46 could use the code constructs of the programming language to select a first set of one or more code regions as a first code segment for possible execution in the main thread, and a second set of one or more code regions of similar size as the first code segment for possible execution in one or more speculative threads. As one with ordinary skill in the art will recognize, the number of potential selections can be large, especially as the regions identified by the region identifier 42 may overlap. Thus, the candidate evaluator 48 evaluates the code segments selected by the candidate selector 46 using various criteria, for example, the size of the selected code segments, and the likelihood that the code segments will be reached during program execution. As one having ordinary skill in the art will appreciate, larger code segments, in which the segments in the main thread and in the one or more speculative parallel threads substantially overlap, result in more parallelism and, thus, a greater potential for improving overall program execution speed. The likelihood of code segment execution provides an indication of how probable the desired parallelism will be achieved by using the selected code segments. The likelihood of code segment execution may be determined through a program flow analysis. Program flow analysis may be based on heuristic rules that estimate this likelihood by using the code constructs in the code segment to make assumptions regarding the program control flow. For example, the candidate evaluator 48 could assume an evenly distributed probability for each control flow branch within the selected code segments. Program flow analysis may also be based on profiling information, if available, to yield an even more accurate estimate of the likelihood of code segment execution. One having ordinary skill in the art will realize that other techniques may be used to conduct the program flow analysis on the selected code segments.

If the candidate selector 46 and candidate evaluator 48 determine that the region is a good candidate for execution in a speculative parallel thread (block 230), control advances to block 250. Otherwise, the candidate selector 46 adds the region to the main thread for the next speculative parallel candidate under consideration (block 240).

Assuming, for purpose of discussion, that the region has been added to the main thread (block 240), the candidate identifier 14 determines if there are more code regions to process (block 330 of FIG. 8B). If there are more regions to process, control returns to block 220. If there are no more code regions to process (block 330 of FIG. 8B), the candidate identifier 14 stores the speculative parallel thread candidates in memory 30, for example, in a candidate array. As described previously, there are many ways to store the speculative parallel thread candidates in memory. For example, the candidate array 30 could contain descriptions of the speculative parallel thread candidates sufficient to reconstruct the candidates from the original program code. In another example, the candidate array 30 could contain copies of the portions of the original program code that comprise each speculative parallel thread candidate. In a third, preferred example, the candidate array 30 could contain pointers to the appropriate code segments in the original program code that comprise the speculative parallel thread candidate. Once the candidate array 30 is stored, the program of FIGS. 8A-8B terminates.

If the region could be executed in a speculative parallel thread (block 230), then control passes to block 250. If the region could be added to an existing speculative parallel thread candidate (block 250), then the candidate evaluator 48 adds the region to the existing speculative parallel thread candidate (block 260). Control then passes to block 280 of FIG. 8B. If the region should be used to start a new speculative parallel thread (block 250), the candidate evaluator 48 labels this region as the start of a new speculative parallel thread candidate (block 270). Control then passes to block 280 of FIG. 8B. In this example, the candidate evaluator 48 maintains a record containing information to describe the speculative parallel thread candidate. The candidate evaluator 48 updates existing records or creates new records based on the program flow described above.

In the illustrated example, the candidate evaluator 48 and the metric estimator and transformer 16 operate in a feedback configuration so that a good cost metric can be determined for the speculative parallel thread candidate. In this configuration, the metric estimator and transformer 16 may perform different transformations on the speculative parallel thread candidate, each yielding a potentially different cost metric. The metric estimator and transformer 16 may continue performing these transformations, for example, until exhausting all possible transformations defined for the code constructs contained within the candidate, or until a minimum, or sufficiently small, cost metric is achieved. In another example, the metric estimator and transformer 16 may continue performing transformations until a predetermined maximum number of attempts is reached. Once the appropriate stopping criteria is met, the metric estimator and transformer 16 selects the minimum, or sufficiently small, cost metric (and corresponding transformation if appropriate) for the speculative parallel thread candidate.

In the example of FIGS. 8A-8B, the metric estimator and transformer 16 determines the cost metric for the speculative parallel thread candidate (block 280 of FIG. 8B). The metric estimator and transformer 16 then determines if it is possible to perform a code transformation on the speculative parallel thread candidate (block 285), for example, if one or more transformations are defined for the code constructs present in the candidate. If a transformation is possible, the metric estimator and transformer 16 compares the cost of the most recent transformation of the speculative parallel thread candidate to any previous transformations, if available (block 290). Then, if a minimum, or sufficiently small, cost has not been achieved, the metric estimator and transformer 16 performs another transformation on the candidate (block 300) and determines the cost metric for the transformed candidate (block 280).

If a minimum, or sufficiently small, cost metric for the speculative parallel thread candidate is achieved (block 290), or if it is not possible to perform a code transformation on the candidate (block 285), control passes to block 310. The metric estimator and transformer 16 may then determine additional information for the speculative parallel thread candidate (block 310). For example, the metric estimator and transformer 16 may provide a description of the transformations performed on the speculative parallel thread during the determination of its cost metric. As discussed above, the candidate evaluator 48 may provide additional information, such as, the size of the speculative parallel thread candidate and/or the likelihood that, during program execution, the code segments in the main thread of the speculative parallel thread candidate will reach the code segments in the speculative parallel thread(s) of the speculative parallel thread candidate. The metric estimator and transformer 16 and candidate evaluator 48 then store this information in memory 30, for example, by updating or appending information to the corresponding candidate record (block 320). Control then passes to block 330.

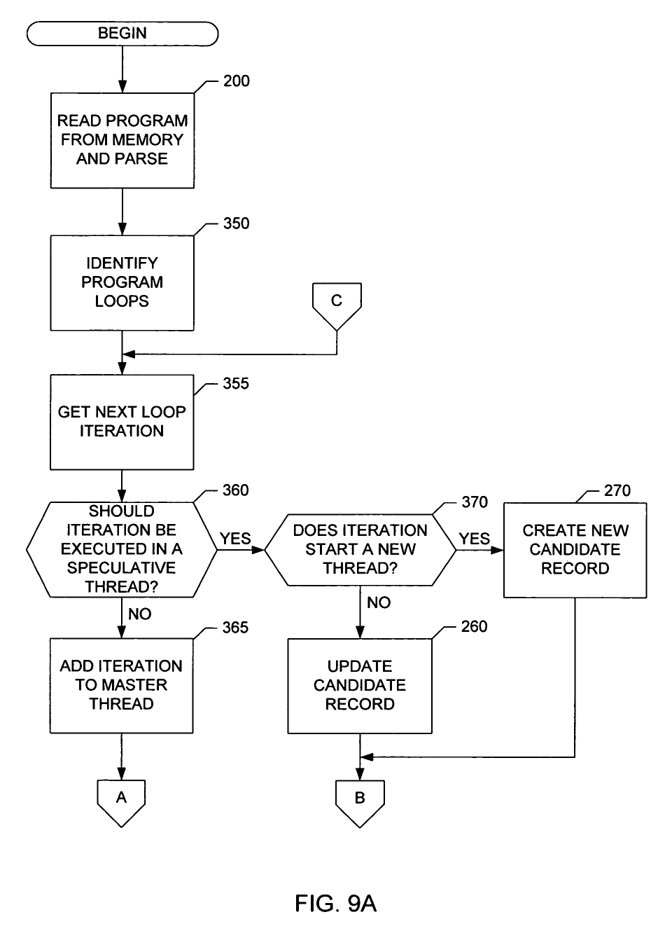

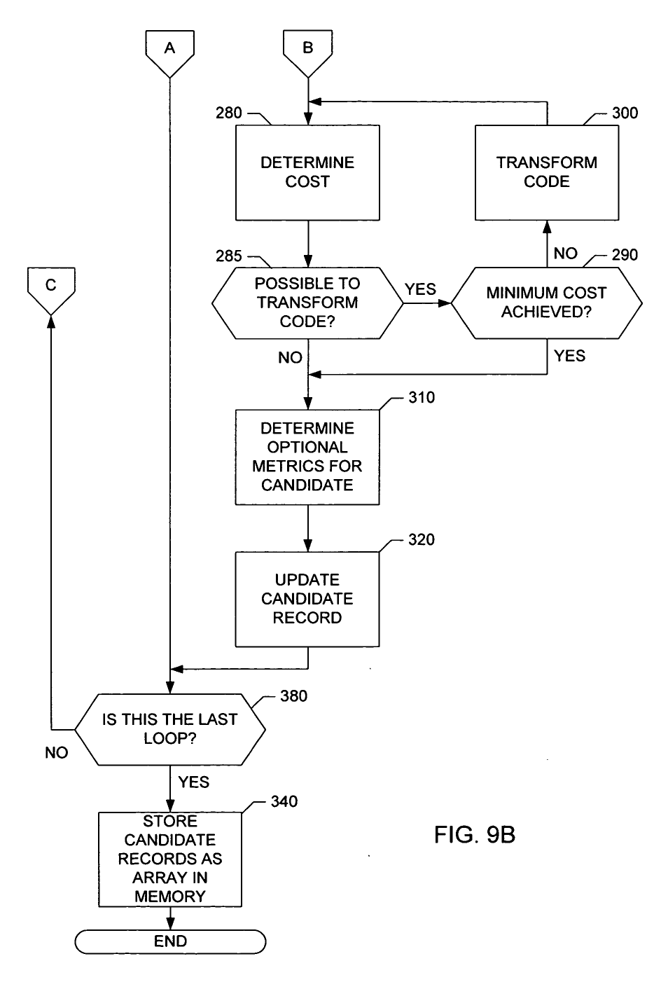

It should be noted that speculative parallel thread candidates comprising program loops can be identified using a program similar to the one shown in FIGS. 8A-8B. For example, the program of FIGS. 8A-8B can be modified as shown in FIGS. 9A-9B. As there is significant overlap between the flowcharts of FIGS. 8A-8B and 9A-9B, in the interest of brevity, identical blocks appearing in both figures will not be re-described here. Instead, the interested reader is referred to the above description of FIGS. 8A-8B for a complete description of the corresponding blocks. To assist the reader in this process, substantially identical blocks are labeled with identical reference numerals in the figures.

Comparing FIGS. 8A-8B to FIGS. 9A-9B, block 210 of FIG. 8A is replaced with block 350 wherein the loop identifier 44 identifies program loops in the original program code. Block 220 is replaced with block 355 wherein the candidate identifier 14 retrieves the next program loop to process. Blocks 230, 240, 250 and 330 of FIGS. 8A-8B are replaced by blocks 360, 365, 370 and 380 of FIGS. 9A-9B, respectively, and the corresponding decisions are then performed on the program loop read by block 355.

One having ordinary skill in the art will appreciate that the programs of FIGS. 8A-8B and 9A-9B, or portions thereof, may need to be executed multiple times to sufficiently identify the various speculative parallel thread candidates resulting from different permutations of the selected program regions and/or loops.

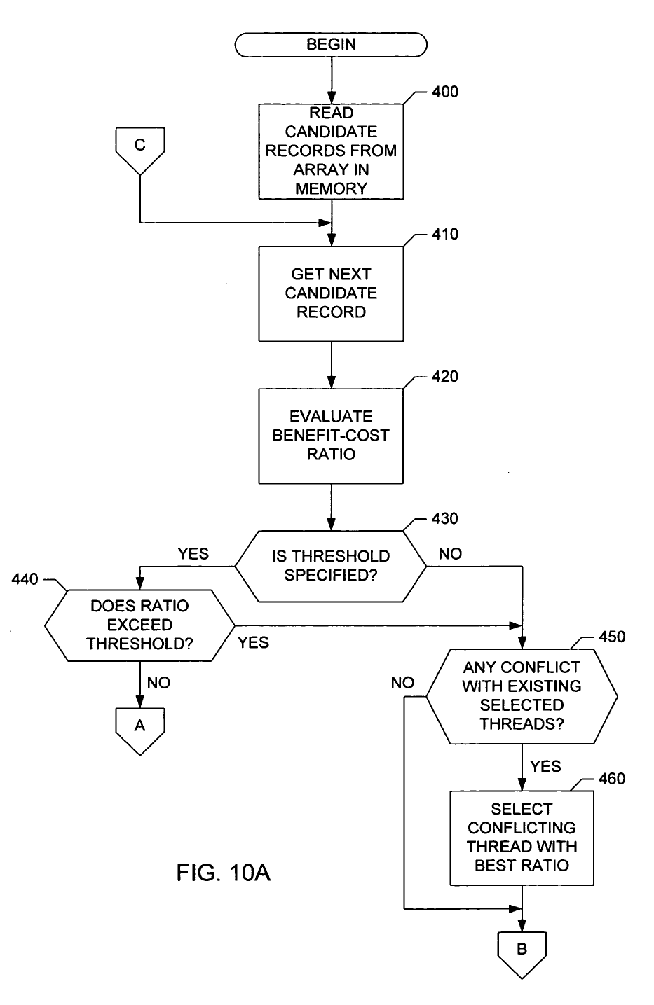

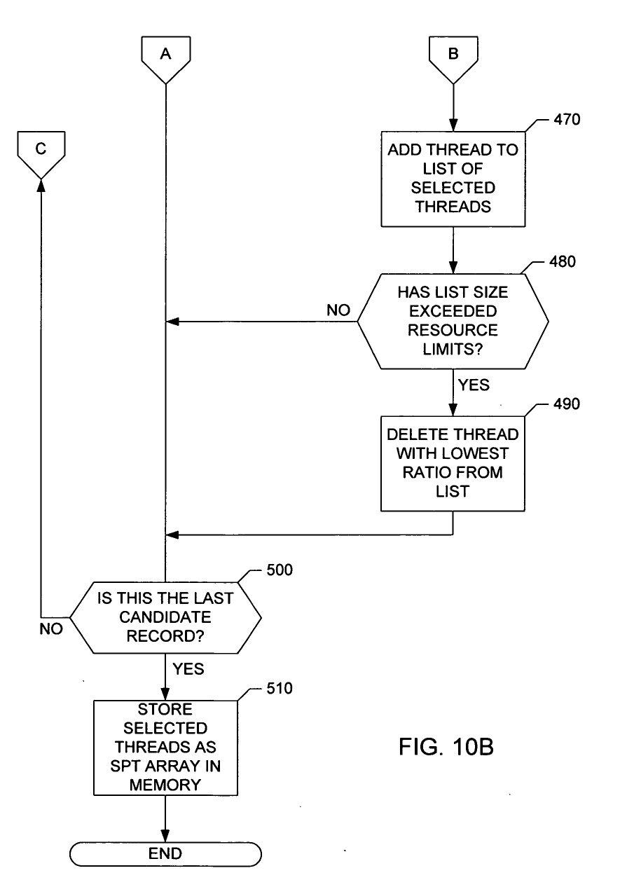

An example program to select the speculative parallel threads from the speculative parallel thread candidates is shown in FIGS. 10A-10B. The program begins at block 400 where the SPT selector 20 reads the speculative parallel thread candidates from memory 30. As explained above, in the illustrated example the speculative parallel thread candidates are stored as candidate records in a candidate array 30. Once the candidate records are retrieved, the SPT selector 20 gets the first candidate record to process (block 410). The metric evaluator 100 determines a benefit-cost ratio for the speculative parallel thread candidate (block 420). As described previously, there are many ways that the metric evaluator 100 could determine the benefit-cost ratio for the speculative parallel thread candidate based on the available information. For example, the benefit-cost ratio may be determined by weighting the size of the speculative parallel thread candidate by the likelihood that this candidate will occur in the execution flow, and then inversely weighting by the cost so that a lower cost results in a larger benefit.

To reduce the compilation resources or time spent generating code for speculative parallel threads having limited benefit to the overall program execution, a predetermined threshold could be specified in an example SPT selector 20. If this threshold is specified (block 430), then the metric comparator 102 compares the benefit-cost ratio to the threshold (block 440). If the benefit-cost ratio does not exceed the threshold (block 440), then control passes to block 500 of FIG. 10B. If there are more speculative parallel thread candidates to process (block 500), then control returns to block 410 of FIG. 10A. If there are no more candidates to process (block 500), then the SPT selector 20 stores the selected speculative parallel threads in memory 30 (block 510).

As described previously, there are many ways to store the speculative parallel threads in memory. For example, the SPT array 30 could contain a description of the speculative parallel threads sufficient to reconstruct the thread from the original program code. Alternatively, the SPT array 30 could contain a copy of the portions of the original program code that comprise each speculative parallel thread. In a third, preferred example, the SPT array 30 could contain pointers to the appropriate code segments in the original program code that comprise the speculative parallel thread. Once the SPT array 30 is stored, the program of FIGS. 10A-10B terminates.

Returning to block 430 of FIG. 10A, if a benefit-cost threshold is not specified (block 430), or if the threshold is specified (block 430) and the metric comparator 102 determines that the benefit-cost ratio for the speculative parallel thread candidate exceeds the threshold (block 440), control passes to block 450. If the metric comparator 102 determines that the speculative parallel thread candidate does not conflict with any other candidates (block 450), control passes to block 470 of FIG. 10B. If the metric comparator 102 identifies a conflict (block 450), then the metric comparator 102 selects non-conflicting candidates based on their benefit-cost ratios (block 460), and control passes to block 470 of FIG. 10B. Example conflicts include cases where two or more candidates contain substantially similar program regions and/or substantially similar or overlapping program loops (e.g., in the case of nested loops).

Once the metric comparator 102 determines that the speculative parallel thread candidate has a benefit-cost ratio that exceeds the predetermined threshold, if it exists, and that it has the best benefit-cost ratio compared to any other conflicting candidates, the metric comparator 102 adds the candidate to the set of speculative parallel threads (block 470). The compiler may impose a predetermined limit on the number of speculative parallel threads, for example, due to physical architecture constraints or compiler resource limitations. If the metric comparator 102 determines that the number of speculative parallel threads has not exceeded this limit (block 480), then control passes to block 500. If the metric comparator 102 determines that the number of speculative parallel threads has exceeded this limit (block 480), then the metric comparator 102 deletes the appropriate thread with the lowest benefit-cost ratio from the set of speculative parallel threads (block 490). Control then passes to block 500.

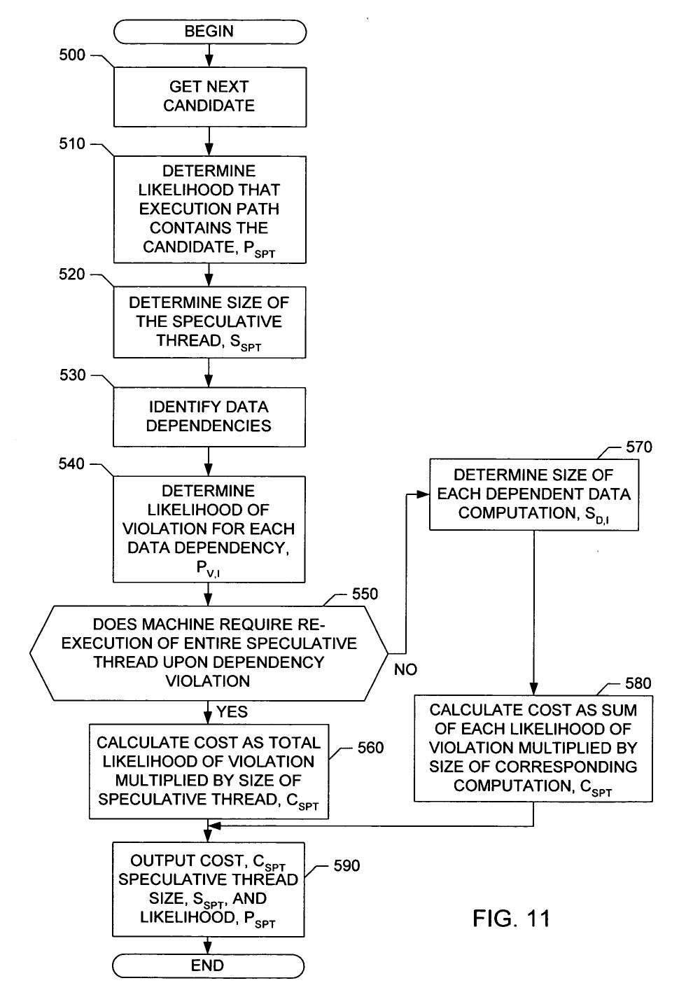

An example program to determine the cost metric and additional information for a speculative parallel thread candidate is shown in FIG. 11. The program begins at block 500 where the metric estimator and transformer 16 gets the next speculative parallel thread candidate from memory. For this example, the metric estimator and transformer 16 determines the likelihood that, during program execution, the code segments in the main thread of the speculative parallel thread candidate will reach the code segments in the speculative parallel thread(s) of the speculative parallel thread candidate. As one having ordinary skill in the art will appreciate, this likelihood of execution could be determined in various ways. For example, the metric estimator and transformer 16 could use a predetermined set of heuristics to estimate the likelihood of execution based on the programming language constructs encountered in the speculative parallel thread candidate. In another example, the metric estimator and transformer 16 could use profiling information, if available, to estimate the likelihood of execution. In yet another example, the metric estimator and transformer 16 could use a predetermined value for the likelihood of execution for the speculative parallel thread candidate.

In the example of FIG. 11, the metric estimator and transformer 16 also determines the size of the speculative parallel thread candidate (block 520). Then, to determine the cost metric, the metric estimator and transformer 16 identifies any data dependencies in the speculative parallel thread candidate (block 530). For a given data dependency, the metric estimator and transformer 16 determines the likelihood that a dependency violation will occur (block 540). Control then passes to block 550. As described previously, there are many ways to determine this probability. For example, the metric estimator and transformer 16 could employ a predetermined set of heuristics based on the programming language constructs within the speculative parallel thread candidate. In another example, the metric estimator and transformer 16 could use profiling information, if available, to estimate the probability that a violation will occur for the data dependency. In yet another example, the metric estimator and transformer 16 could assume a predetermined probability for the dependency violation.

In the example illustrated in FIG. 11, the cost metric is the misspeculation cost. So, if the physical architecture requires that the entire speculative parallel thread be re-executed upon occurrence of a dependency violation (block 550), then the metric estimator and transformer 16 determines the misspeculation cost by multiplying the size of the speculative parallel thread candidate by the total probability of any data dependency violation for this candidate (block 560). The metric estimator and transformer 16 then stores the cost metric and additional information for the speculative parallel thread candidate in memory 30 (block 590). Once this information is stored, the program of FIG. 11 terminates.

If the physical architecture permits only the affected computations to be re-executed upon a dependency violation (block 550), then the metric estimator and transformer 16 determines the amount of computation required to recover from the individual data dependency violations in the speculative parallel thread candidate (block 570). These quantities are also known as recovery computation sizes. The metric estimator and transformer 16 then determines the misspeculation cost by totaling the likelihood of each possible data dependency violation for this candidate weighted by the recovery computation size for the dependency violation (block 580). Control then passes to block 590.

One having ordinary skill in the art will appreciate that other example programs may be used to determine the cost metric and additional information for the speculative parallel thread candidate. For example, the metric estimator and transformer 16 could reuse the size and likelihood information provided by the candidate evaluator 48 and stored in memory 30 rather than re-compute this information as illustrated in FIG. 11.

FIG. 12 is a block diagram of an example computer 1000 capable of implementing the apparatus and methods disclosed herein. The computer 1000 can be, for example, a server, a personal computer, a personal digital assistant (PDA), an Internet appliance, or any other type of computing device.

The system 1000 of the instant example includes a processor 1012. For example, the processor 1012 can be implemented by one or more Intel® microprocessors from the Pentium® family, the Itanium® family or the XScale® family. Of course, other processors from other families are also appropriate. While a processor 1012 including only one microprocessor might be appropriate for implementing the apparatus 10 of FIG. 1, to execute a program optimized by the apparatus 10 of FIG. 1, the processor 1012 should include two or more microprocessors to enable parallel execution of a main thread and one or more parallel threads.

The processor 1012 is in communication with a main memory including a volatile memory 1014 and a non-volatile memory 1016 via a bus 1018. The volatile memory 1014 may be implemented by Static Random Access Memory (SRAM), Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1016 may be implemented by flash memory and/or any other desired type of memory device. Access to the main memory 1014, 1016 is typically controlled by a memory controller (not shown) in a conventional manner.

The computer 1000 also includes a conventional interface circuit 1020. The interface circuit 1020 may be implemented by any type of well known interface standard, such as an Ethernet interface, a universal serial bus (USB), and/or a third generation input/output (3GIO) interface.

One or more input devices 1022 are connected to the interface circuit 1020. The input device(s) 1022 permit a user to enter data and commands into the processor 1012. The input device(s) can be implemented by, for example, a keyboard, a mouse, a touchscreen, a track-pad, a trackball, an isopoint and/or a voice recognition system.

One or more output devices 1024 are also connected to the interface circuit 1020. The output devices 1024 can be implemented, for example, by display devices (e.g., a liquid crystal display, a cathode ray tube display (CRT)), by a printer and/or by speakers. The interface circuit 1020, thus, typically includes a graphics driver card.

The interface circuit 1020 also includes a communication device such as a modem or network interface card to facilitate exchange of data with external computers via a network 1026 (e.g., an Ethernet connection, a digital subscriber line (DSL), a telephone line, coaxial cable, a cellular telephone system, etc.).

The computer 1000 also includes one or more mass storage devices 1028 for storing software and data. Examples of such mass storage devices 1028 include floppy disk drives, hard drive disks, compact disk drives and digital versatile disk (DVD) drives. The mass storage device 1028 may implement the memory 30. Alternatively, the volatile memory 1014 may implement the memory 30.

As an alternative to implementing the methods and/or apparatus described herein in a system such as the device of FIG. 12, the methods and or apparatus described herein may alternatively be embedded in a structure such as a processor and/or an ASIC (application specific integrated circuit).

From the foregoing, persons of ordinary skill in the art will appreciate that the above disclosed methods and apparatus may be implemented in a static compiler, a managed run-time environment just-in-time (JIT) compiler, and/or directly in the hardware of a microprocessor to achieve performance optimization in executing various programs. Moreover, the above disclosed methods and apparatus may be implemented to operate as a single pass through the original program code (e.g., perform a speculative parallel thread selection after identification of a speculative parallel thread candidate), or as multiple passes through the original program code (e.g., perform speculative parallel thread selection after identification of the set of speculative parallel thread candidates). In the latter approach, an example implementation could have the candidate identifier 14 and metric estimator and transformer 16 operate in a first pass through the original program code, and the SPT selector 20 and code generator 22 operate in a second pass through the original program code.

Although certain example methods and apparatus have been described herein, the scope of coverage of this patent is not limited thereto. On the contrary, this patent covers all methods, apparatus and articles of manufacture fairly falling within the scope of the appended claims either literally or under the doctrine of equivalents.

1. A method of compiling a program comprising:
identifying a set of speculative parallel thread candidates;
determining cost values for at least some of the speculative parallel thread candidates;
selecting a set of speculative parallel threads from the set of speculative parallel thread candidates based on the cost values; and
generating program code based on the set of speculative parallel threads.

2. A method as defined in claim 1 wherein identifying the set of speculative parallel thread candidates comprises identifying program regions.

3. A method as defined in claim 1 wherein at least one of the speculative parallel thread candidates comprises at least one program region.

4. A method as defined in claim 1 wherein at least one of the speculative parallel threads comprises at least one program region.

5. A method as defined in claim 1 wherein identifying the set of speculative parallel thread candidates comprises identifying program loops.

6. A method as defined in claim 1 wherein at least one of the speculative parallel thread candidates comprises a program loop.

7. A method as defined in claim 1 wherein at least one of the speculative parallel threads comprises a program loop.

8. A method as defined in claim 1 wherein identifying the set of speculative parallel thread candidates comprises identifying a main thread.

9. A method as defined in claim 8 wherein the main thread comprises a current iteration of a program loop, and the speculative parallel thread candidate comprises a next iteration of the same program loop.

10. A method as defined in claim 8 wherein the main thread comprises a current iteration of a program loop, and the speculative parallel thread comprises a next iteration of the same program loop.

11. A method as defined in claim 1 wherein the cost value is a misspeculation cost.

12. A method as defined in claim 111 wherein determining the misspeculation cost comprises:
identifying a data dependency in the speculative parallel thread candidate;
determining, for the data dependency, a likelihood that a dependency violation will occur; and
determining an amount of computation required to recover from the data dependency violation.

13. A method as defined in claim 1 further comprising determining at least one of the following for at least one of the speculative parallel thread candidates:
a size of the speculative parallel thread candidate; and
a likelihood representative of the speculative parallel thread candidate.

14. A method as defined in claim 1 wherein at least one of the speculative parallel thread candidates is transformed prior to determining the cost value for the at least one of the speculative parallel thread candidates.

15. A method as defined in claim 14 wherein the at least one of the speculative parallel thread candidates is transformed by a code reordering.

16. A method as defined in claim 14 further comprising determining at least one of the following for at least one of the speculative parallel thread candidates:
a size of the speculative parallel thread candidate;
a likelihood representative of the speculative parallel thread candidate; and
a description of the transformation performed on the speculative parallel thread candidate.

17. A method as defined in claim 1 wherein at least one of the speculative parallel threads is transformed prior to code generation.

18. A method as described in claim 17 wherein the at least one of the speculative parallel threads is transformed by code reordering.

19. An article of manufacture storing machine readable instructions that, when executed, cause a machine to:
identify a set of speculative parallel thread candidates;
determine a cost value for at least one of the speculative parallel thread candidates;
select a set of speculative parallel threads from the set of speculative parallel thread candidates based on the cost values; and
generate program code based on the set of speculative parallel threads.

20. An article of manufacture as defined in claim 19 wherein the cost value is a misspeculation cost.

21. An article of manufacture as defined in claim 20 wherein, to determine the misspeculation cost, the machine readable instructions cause the machine to:
identify a data dependency in the speculative parallel thread candidate;
determine, for the data dependency, a likelihood that a dependency violation will occur; and
determine an amount of computation required to recover from the data dependency violation.

22. An article of manufacture as defined in claim 19 wherein the machine readable instructions cause the machine to determine at least one of the following for at least one of the speculative parallel thread candidates:
a size of the speculative parallel thread candidate; and
a likelihood representative of the speculative parallel thread candidate.

23. An article of manufacture as defined in claim 19 wherein the machine readable instructions cause the machine to transform at least one of the speculative parallel thread candidates prior to determining the cost value.

24. An apparatus to compile a program comprising:
a candidate identifier to identify a set of speculative parallel thread candidates;
a metric estimator to determine a cost value for at least one of the speculative parallel thread candidates;
a speculative parallel thread selector to select a set of speculative parallel threads from the set of speculative parallel thread candidates based on the cost values; and
a code generator to generate program code based on the set of speculative parallel threads.

25. An apparatus as defined in claim 24 wherein the candidate identifier comprises a region identifier to identify program regions.

26. An apparatus as defined in claim 24 wherein the candidate identifier comprises a loop identifier to identify program loops.

27. An apparatus as defined in claim 24 wherein the candidate identifier comprises a candidate selector to select a first one of a program region and a program loop iteration to execute in a main thread, and to select a second one of a program region and a program loop iteration to execute in a speculative parallel thread.

28. An apparatus as defined in claim 24 wherein the metric estimator determines a misspeculation cost.

29. An apparatus as defined in claim 24 wherein the metric estimator comprises:
a data dependency identifier to identify a data dependency in the speculative parallel thread candidate;
a likelihood evaluator to determine a likelihood that a dependency violation will occur; and
a recovery size calculator to determine an amount of computation required to recover from the data dependency violation.

30. An apparatus as defined in claim 24 wherein the candidate identifier determines at least one of the following for at least one of the speculative parallel thread candidates:
a size of the speculative parallel thread candidate; and
a likelihood representative of the speculative parallel thread candidate.

31. A system to compile a program comprising:
a candidate identifier to identify a set of speculative parallel thread candidates;
a metric estimator to determine a cost value for at least one of the speculative parallel thread candidates;
a speculative parallel thread selector to select a set of speculative parallel threads from the set of speculative parallel thread candidates based on the cost values;
a code generator to generate program code based on the set of speculative parallel threads; and
a static random access memory to store the cost values.

32. A system as define in claim 31 wherein the metric estimator comprises:
a data dependency identifier to identify a data value dependency in the speculative parallel thread candidate;
a likelihood evaluator to determine a likelihood that a dependency violation will occur; and
a recovery size calculator to determine a set of recovery computation sizes that represent an amount of computation required to recover from the data dependency violation.
